(19) United States
(12) Patent Application Publication
(10) Pub. No.: US 2013/0176407 A1
(43) Pub. Date: Jul. 11, 2013

(54) Beam scanned display apparatus and method thereof

(71) Applicant: RealD Inc., Beverly Hills, CA (US)

(72) Inventors: Kevin R. Curtis, Longmont, CO (US); Gary D. Sharp, Boulder, CO (US); Miller H. Schuck, Erie, CO (US)

(73) Assignee: REALD INC., Beverly Hills, CA (US)

(21) Appl. No.: 13/734,519

(22) Filed: Jan. 4, 2013

Related U.S. Application Data
(60) Provisional application No. 61/583,487, filed on Jan. 5, 2012.

(51) Int. Cl. H04N 13/04

(52) U.S. Cl. CPC H04N 13/0422
USPC 348/52

(57) ABSTRACT

Generally, display systems may be employed in cinema and exhibition applications. Laser scanned display systems may be enabled such that the display systems may display three dimensional (“3D”) content. One example of a display system may include a diffusive screen which may be a transmissive diffuser and at least a light engine or an array of light engines, in which the light engine or array of light engines may include at least a light source, beam combining optics which may combine colors into at least one of a single beam or closely spaced beams, and at least a scanning system which may steer the beam to a desired location on the diffusive screen.

### CROSS-REFERENCE TO RELATED APPLICATIONS

This application relates to and claims priority to U.S. Provisional Patent Application Ser. No. 61/583,487, filed Jan. 5, 2012 entitled “Beam scanned display apparatus and method thereof”, the entirety of which is herein incorporated by reference.

### TECHNICAL FIELD

The present disclosure generally relates to display systems, and more specifically, to two dimensional and three dimensional display technologies, systems, and components.

### BRIEF SUMMARY

According to one embodiment of the present disclosure a stereoscopic display system may include a light source operable to produce light and a scanning system operable to scan a beam. The stereoscopic display system may also include at least a first substrate and a second substrate joined together and operable to receive light from the light source and an FPR layer proximate to at least one of the first or second substrate. In one example, the light source may produce at least three colors of light and the three colors may be primary colors of light which may be substantially red, green, and blue. The stereoscopic display system may include a polarizer proximate to the FPR layer. In another example, the light source may include a first beam and a second beam and the first and second beam may be polarized. The light from the first beam and the light from the second beam may be substantially combined by a polarizing beam splitter. Continuing the example, the light from the first beam may encounter a reflective element such as a mirror and be reflected toward the polarizing beam splitter and the light from the second beam may encounter the polarizing beam splitter. After the light from the first and second beams leave the polarizing beam splitter, the light may be substantially combined into a single beam or into closely spaced beams. Additionally, the first beam and the second beam may scan multiple lines substantially simultaneously.

In another example the light source may include a first beam, a second beam, and a third beam, and the light from each of the first, second, and third beam may be substantially combined primarily using dichroic filters.

In another example, the light source may include a first beam, a second beam, and a third beam, and the light from each of the first, second, and third beam may be substantially combined primarily using a mirror array structure.

In yet another example, the light source may include a first beam, a second beam, and a third beam, and the light from each of the first, second, and third beam may be substantially combined primarily using a fiber combiner and a collimating lens.

The stereoscopic display system may also include an array of light engines for illuminating at least the first and second substrate and in one example, the first substrate and the second substrate may be transmissive, diffusive substrates. The stereoscopic display system may also include beam combining optics which may substantially combine colors into at least one of a single beam or closely spaced beams. Additionally, the stereoscopic display system may include at least a rotating polygon mirror for steering the beam to a desired location on at least the first or second substrate. In another example, the scanning system may include a galvo mirror. The galvo mirrors may rotate on different axes. The galvo mirrors may be located close together in which the proximity of the mirrors to one another may be dependent on the size of the galvo mirrors.

According to another embodiment of the present disclosure a stereoscopic scanned laser display system may include a light source operable to produce light and a scanning system operable to scan a beam, at least a first substrate operable to receive light from the light source, and an FPR layer proximate to the first substrate. The light source may produce at least three primary colors of light that may be substantially red, green, and blue. The stereoscopic scanned laser display system may include a polarizer proximate to the FPR layer. In one example, the light source may include a first beam and a second beam, both of which may be polarized. The light from the first beam and the light from the second beam may be substantially combined primarily by a polarizing beam splitter. Additionally, the first beam and the second beam may scan multiple lines substantially simultaneously.

In one example, the light source of the stereoscopic scanned laser display system may include a first beam, a second beam, and a third beam, and the light from each of the first, second, and third beam may be substantially combined primarily using dichroic filters.

In another example, the light source of the stereoscopic scanned laser display system may include a first beam, a second beam, and a third beam, and the light from each of the first, second, and third beam may be substantially combined primarily using a mirror array structure.

According to another embodiment of the present disclosure a stereoscopic display system may include a light source operable to produce light and a scanning system operable to scan a beam, at least a first substrate and a second substrate which may be joined together and operable to receive light from the light source, an FPR layer proximate to the first and second substrate, and an array of light engines, in which the first substrate may be substantially illuminated by more than an individual light engine of the array of light engines. The stereoscopic display system may further include a polarizer proximate to the FPR layer.

According to yet another embodiment of the present disclosure a stereoscopic display system may include a light source operable to produce light and a scanning system operable to scan a beam and at least a first substrate operable to receive light from the light source. Additionally, the light source may emit at least six colors.

Electronic displays that appear as substantially seamless may be employed for general use in at least cinema and exhibition applications including commercial display applications for business, education, and consumer in home displays. The tiled displays that appear as substantially seamless, may employ specific data formats for use in displaying images on individual displays which may be tiled together to form a larger tiled, near seamless display, and may employ other techniques not utilized in known video wall applications. These functions may include an intensity envelope and may enable laser scanned displays as 3D displays by using either polarization, with or without polarization conversion, multiple colors, or any combination thereof.

Display systems may include a diffusive screen which may be a transmissive diffuser and at least a light engine or an array of light engines, in which the light engine or array of light engines may include at least a light source, beam combining optics which may combine colors into at least one of a single beam or closely spaced beams, and at least a scanning system which may steer the beam to a desired location on the diffusive screen.

### BACKGROUND

Generally, current projection and display technologies may include functionality to deploy, view and/or display three dimensional (“3D”) content. Recently, the increased demand for such functionality has driven the need for enhanced performance of projection and/or display technology, including increasing the brightness of the display. For example, larger displays may include multiple smaller displays tiled together. Such a configuration may be known as a video wall. A video wall may include multiple displays, monitors, projector based displays, televisions, liquid crystal displays, light emitting diode displays, organic light emitting diode displays and so forth, tiled together and adjacent to one another or overlapped to form a larger display. Further, the larger displays may include multiple displays, substrates, screens, monitors, projectors, televisions, LCDs, and so forth, tiled together and adjacent to one another or overlapped to form a larger display.

### BRIEF DESCRIPTION OF THE DRAWINGS

Embodiments are illustrated by way of example in the accompanying figures, in which like reference numbers indicate similar parts, and in which:

FIG. 1 is a schematic diagram illustrating one embodiment of a display system and an enclosure, in accordance with the present disclosure;

FIG. 2 is a schematic diagram illustrating one embodiment of a light engine architecture, in accordance with the present disclosure;

FIG. 3 is a schematic diagram illustrating one embodiment of combining light from multiple source, in accordance with the present disclosure;

FIG. 4 is a schematic diagram illustrating one embodiment of a display with a polarizer and a fixed pattern retarder, in accordance with the present disclosure;

FIG. 5 is a schematic diagram illustrating one embodiment of a display system which may include a substrate, in accordance with the present disclosure;

FIG. 6 is a schematic diagram illustrating examples of envelope functions, in accordance with the present disclosure; and

FIG. 7 is a schematic diagram illustrating embodiments of a parallax-barrier autostereoscopic display and lenticular autostereoscopic display.

### DETAILED DESCRIPTION

According to one embodiment of the present disclosure a stereoscopic display system may include a light source operable to produce light and a scanning system operable to scan a beam. The stereoscopic display system may also include at least a first substrate and a second substrate joined together and operable to receive light from the light source and an FPR layer proximate to at least one of the first or second substrate. In one example, the light source may produce at least three colors of light and the three colors may be primary colors of light which may be substantially red, green, and blue. The stereoscopic display system may include a polarizer proximate to the FPR layer. In another example, the light source may include a first beam and a second beam and the first and second beam may be polarized. The light from the first beam and the light from the second beam may be substantially combined by a polarizing beam splitter. Continuing the example, the light from the first beam may encounter a reflective element such as a mirror and be reflected toward the polarizing beam splitter and the light from the second beam may encounter the polarizing beam splitter. After the light from the first and second beams leave the polarizing beam splitter, the light may be substantially combined into a single beam or into closely spaced beams. Additionally, the first beam and the second beam may scan multiple lines substantially simultaneously.

In another example the light source may include a first beam, a second beam, and a third beam, and the light from each of the first, second, and third beam may be substantially combined primarily using dichroic filters.

In another example, the light source may include a first beam, a second beam, and a third beam, and the light from each of the first, second, and third beam may be substantially combined primarily using a mirror array structure.

In yet another example, the light source may include a first beam, a second beam, and a third beam, and the light from each of the first, second, and third beam may be substantially combined primarily using a fiber combiner and a collimating lens.

The stereoscopic display system may also include an array of light engines for illuminating at least the first and second substrate and in one example, the first substrate and the second substrate may be transmissive, diffusive substrates. The stereoscopic display system may also include beam combining optics which may substantially combine colors into at least one of a single beam or closely spaced beams. Additionally, the stereoscopic display system may include at least a scanning system for steering the beam to a desired location on at least the first or second substrate.

According to another embodiment of the present disclosure a stereoscopic scanned laser display system may include a light source operable to produce light and a scanning system operable to scan a beam, at least a first substrate operable to receive light from the light source, and an FPR layer proximate to the first substrate. The light source may produce at least three primary colors of light that may be substantially red, green, and blue. The stereoscopic scanned laser display system may include a polarizer proximate to the FPR layer. In one example, the light source may include a first beam and a second beam, both of which may be polarized. The light from the first beam and the light from the second beam may be substantially combined primarily by a polarizing beam splitter. Additionally, the first beam and the second beam may scan multiple lines substantially simultaneously.

In one example, the light source of the stereoscopic scanned laser display system may include a first beam, a second beam, and a third beam, and the light from each of the first, second, and third beam may be substantially combined primarily using dichroic filters.

In another example, the light source of the stereoscopic scanned laser display system may include a first beam, a second beam, and a third beam, and the light from each of the first, second, and third beam may be substantially combined primarily using a mirror array structure.

According to another embodiment of the present disclosure a stereoscopic display system may include a light source operable to produce light and a scanning system operable to scan a beam, at least a first substrate and a second substrate which may be joined together and operable to receive light from the light source, an FPR layer proximate to the first and second substrate, and an array of light engines, in which the first substrate may be substantially illuminated by more than an individual light engine of the array of light engines. The stereoscopic display system may further include a polarizer proximate to the FPR layer.

According to yet another embodiment of the present disclosure a stereoscopic display system may include a light source operable to produce light and a scanning system operable to scan a beam and at least a first substrate operable to receive light from the light source. Additionally, the light source may emit at least six colors.

Generally, another embodiment of the present disclosure may take the form of a beam scanned display system. One example of such a display system may include a diffusive screen, which may be a transmissive diffuser and at least a light engine or an array of light engines, in which the light engine or array of light engines may include at least a light source, beam combining optics which may combine colors into at least one of a single beam or closely spaced beams, and at least a scanning system which may steer the beam to a desired location on the diffusive screen.

Some manufacturers such as Toshiba and Prysm have developed displays that use a laser beam scanned in the UV, blue, or green light to excite phosphors from behind the display panel to emit blue, green, and red color on the screen in the direction of the audience. Both Toshiba and Prysm prefer to use laser diodes centered at 405 nm to excite different phosphors as these lasers are high power, low cost, and demonstrate reasonable reliability. These displays can be tiled together to make larger displays as generally discussed in U.S. patent application Ser. No. 13/655,261 and U.S. patent application Ser. No. 13/655,277, both of which are herein incorporated by reference in their entirety. These laser beam scanned displays are typically used for advertising or other applications that do not require high quality displays or high resolution content and do not have 3D viewing capability.

The seams between panels, displays or screens of the laser scanned display may be small and in the approximate range of 0.05 mm-1 mm and can be masked by various methods including, but not limited to, using a diffuser in front of the screen, employing waveguides used on macro-pixels, propagation based elimination, any combination thereof and so forth. Architecture may be employed to comply with DCI issues and formatting as well. Advantages of these displays may include, but are not limited to low energy and very long lifetimes.

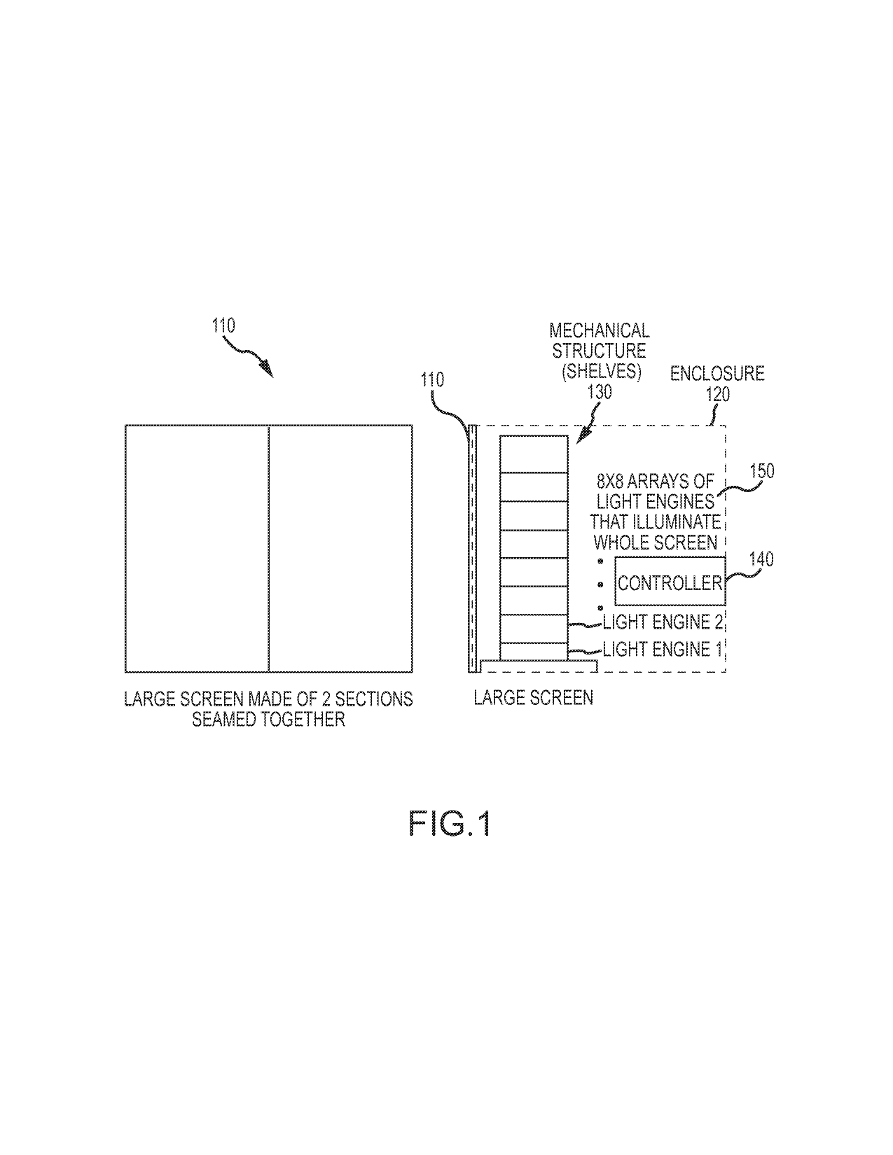

With the development of red, green, and blue, low cost and high power reliable lasers, display systems may use lasers for modulating and scanning different color beams across a diffusive screen. The screen can be any type of diffuser, including, but not limited to a volume diffuser, a surface diffuser, any combination thereof, and so forth. The diffuser may diffuse the red, green and blue light over a wide range of angles, such as greater than approximately 135 degrees, so that the audience can view the images from a wide range of seating positions relative to the screen. The diffuser screen can be manufactured similarly to a general movie screen but differently designed, in one example, as a transmissive diffuser. The scanned color beams can come from a single light engine or several light engines that cover approximately most of or the entire screen as illustrated in FIG. 1.

FIG. 1 is a schematic diagram illustrating one embodiment of a display system and an enclosure. Rather than make individual modules which may include a light engine, a panel/screen, and a mechanical housing, there is an alternative construction as indicated in FIG. 1. FIG. 1 illustrates an example of this system. FIG. 1 illustrates a front view of screen 110 and an enclosure 120 that includes a side view of screen 110. The enclosure 120 includes a mechanical structure 130, a controller 140, and an array of light engines 150. The mechanical structure may be shelves or any type of structure that provides structural support. In the example of FIG. 1, the array of light engines may be an 8×8 array that may substantially illuminate the entire screen. Additionally, the array of light engines may or may not be aligned with the seams in the screen. Further, the screen 110 may be any type of substrate including, but not limited to, PVC, PC, PET, and so forth.

In one embodiment, a large theater sized screen can be manufactured with all of the appropriate layers and coatings by seaming together the panels/screens. Rolls may be made with a transparent substrate which may then be joined and installed, as generally described in U.S. patent application Ser. No. 13/549,304, which is herein incorporated by reference in its entirety. The substrate may be, but is not limited to, PET, PVC, PC, and so forth. Next, the large screen may be installed in the theater and light modules may be arranged behind a portion of the screen and may be illuminated and driven appropriately.

As illustrated in FIG. 1, the light modules and/or engines may be held in a mechanical assembly to approximately maintain a position relative to the corresponding screen portion that may be illuminated and driven by the light module and/or engine. The screen may have servo marks and fiducial markings so that the screen may be self-aligned and/or calibrated on the corresponding portion of the screen that may be illuminated. Also as illustrated in FIG. 1, the whole assembly of light engines or part of the light engines may be enclosed for security and dust protection. The light engines may produce or emit light including, but not limited to, UV, RGB, visible, IR, any combination thereof, and so forth.

Additionally the screen can be manufactured such that the rolls may be approximately the length or height of the entire video wall with seams in one direction. These seams may be hidden by substantially aligning them to pixel gaps. The screen can be suspended by attachment to a frame by springs or other tension mechanisms similar to movie screens. The light engine array may be located behind the screen. The screen can be flat or curved with the light engine array also flat or curved to match the screen. In addition, the screen may be vibrated in a number of ways including, but not limited to, by attaching one or more mechanical transducers to the screen causing small vibrations that can reduce speckle issues.

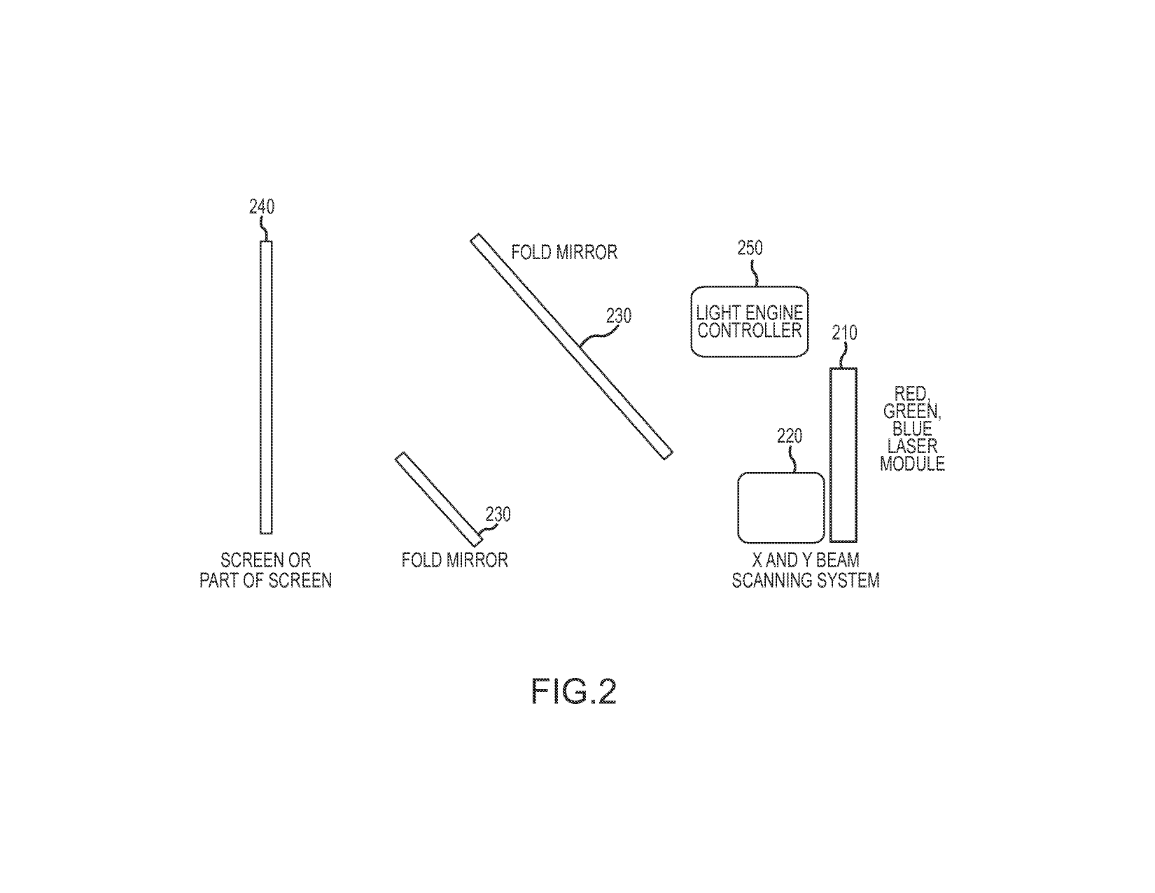

FIG. 2 is a schematic diagram illustrating one embodiment of a light engine architecture. FIG. 2 includes a laser module 210, beam steering optics 220, beam combining optics 230, a light engine controller 250, and a screen 240. The beam steering optics 220 may be part of a scanning system. As illustrated in FIG. 2, a light engine may include at least light sources for each of the appropriate colors, beam combining optics to substantially combine the colors into a single beam or closely spaced beams, and a scanning system including beam steering optics such as galvo mirrors to steer the beams to locations on the screen. Other beam steering devices may be used such as, but not limited to, micromechanical mirrors, rotating polygon mirrors, acoustical modulators, electro-optical modulators to change the direction of the beam, and so forth. The light engine controller 250 may control at least the power of the lasers and scanning positions. The controller converts the incoming data into color brightness and location information.

The light intensity of the lasers may be modulated while scanning across a screen so that the color and brightness of a pixel on the screen may be determined by the modulated laser beams. The controller may determine the appropriate modulation using calibration data stored during or after installation. The modulation may be achieved in various ways, including in one example, by changing the driving current provided to the various lasers which may change the light output from the lasers. For example, a red pixel may be generated by allowing light to pass from a red laser, turning on the red laser, or adjusting the red laser to a specific brightness which may depend on the desired brightness of the pixel in the image, and either omitting the light from or turning off the blue and green lasers. By adjusting the total and relative brightness of the three lasers at a given scan position (pixel on screen location) the entire color gamut and intensity range for presenting images, content, movies, and so forth, can be generated. The total color gamut may be approximately determined by the actual wavelengths of the lasers used and can exceed the color gamut that can be generated by using a lamp. Laser sources may include, but are not limited to, laser diodes including single devices, groups of devices combined together, or laser bars, light emitting diodes (LEDs), vertical cavity surface emitting lasers (VCSELs), 1D or 2D VCSEL arrays, doubled VCSEL arrays, doubled solid state laser sources, any combination thereof, and so forth. The laser sources can be single frequency, for example, approximately 0.1 nm width or may be very wide spectrums, for example in the approximate range of 1-30 nm. Wider spectrum lasers sources may have fewer speckle problems.

Further, in one example, light may be provided to a light engine by a remote laser module and be fiber coupled into the laser light engine. Stated differently, the remote laser module may be located outside of the light engine structure. The intensity modulation can be achieved, for example, but not limited to, by electro-optical, micromechanical, acoustic optical modulators, pulsing the current, and so forth, so that a full range of colors can be displayed. In addition to visible light for displaying the image pixels on the screen, an infrared laser beam can be used that may co-propagate with the visible beams and reflect off of fiducial marks or may track on the screen back. The backscatter may then be detected by a detector to help track and scan the light correctly across the diffusing screen. Generally, at least three colors are needed, such as red, green, and blue, to achieve a full color display. However, more colors can be used to achieve better color range (gamut) and/or to achieve a 3D effect, which will be discussed in further detail herein. Generally, red lasers may be in the approximate range of 610-660 nm, green or yellow lasers may be in the approximate range of 500-600, and blue lasers may be in the approximate range of 405-495 nm. For example, by selecting primaries at approximately 465, 532, and 640 nm, a color gamut that is nearly 30% larger than a typical lamp based projector can be achieved.

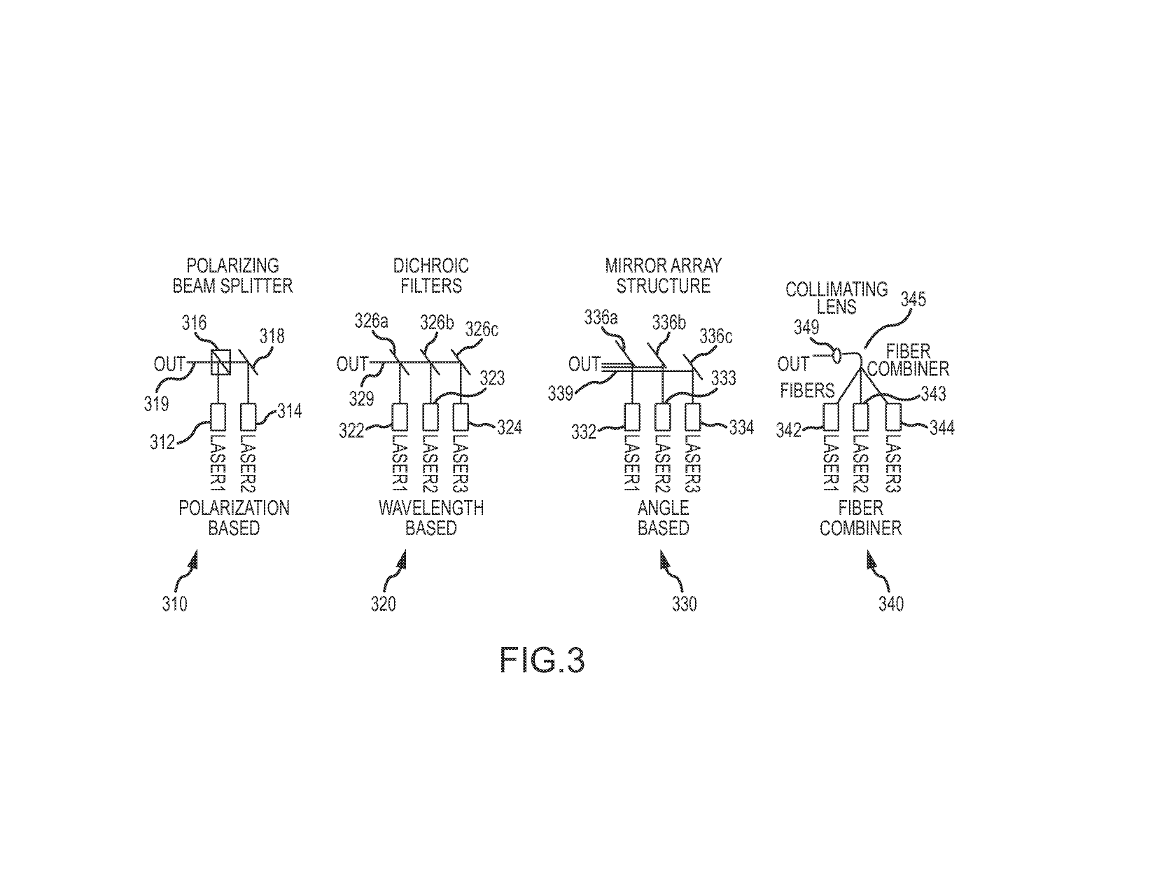

FIG. 3 is a schematic diagram illustrating one embodiment of combining light from multiple sources. Further, FIG. 3 illustrates examples of how light from multiple sources can be combined into co-propagating beams or into a single beam that can be used in the light engine. The techniques used for combining beams may include, but are not limited to, using polarization, angle, wavelength properties of the light, using optical fiber, any combination thereof, and so forth.

In FIG. 3, a polarization based light source 310 may include a first laser 312 and a second laser 314. The first laser may provide light to a polarizing beam splitter 316 along a first light path and the second laser may provide light to a polarizing element 318 along a second light path. After encountering the polarizing beam splitter 316 and the polarizing element 318, the light along the first and second light path may substantially combine into a third output light path 319. The polarizing light may be circularly polarized, linearly polarized, and so forth.

Also, in FIG. 3, a wavelength based light source 320 may include a first laser 322, a second laser 323, and a third laser 324. The first laser may provide light to a first dichroic filter 326a along a first light path, the second laser may provide light to a second dichroic filter 326b along a second light path, and the third laser may provide light to a third dichroic filter 326c along a third light path. After encountering the dichroic filters 326a, 326b, 326c, the light along the first, second, and third light path may substantially combine into a fourth output light path 329.

Additionally in FIG. 3, an angle based light source 330 may include a first laser 332, a second laser 333, and a third laser 334. The first laser may provide light to a first reflective element 336a along a first light path, the second laser may provide light to a second reflective element 336b along a second light path, and the third laser may provide light to a third reflective element 336c along a third light path. After encountering the reflective elements 336a, 336b, 336c, the light along the first, second, and third light path may travel substantially in the same direction as a fourth output light path 339. The reflective elements 336a, 336b, 336c, may be in one example, mirrors and together, may form a mirror array structure.

Additionally in FIG. 3, a fiber combiner system 340 may include a first laser 342, a second laser 343, and a third laser 344. The first laser, second laser, and third laser may provide light to a fiber combiner 345. After encountering the fiber combiner 345, the light from the first, second, and third laser may encounter an optical element 349. The optical element 349 may be in one example, a collimating lens.

A light engine with multiple lower power laser primary sets may scan more than one line at a time. For example, a light engine with 20 sets of red, green, and blue lasers can scan 20 lines at a time by modulating the out of the sets of lasers to achieve the appropriate color and brightness per pixel in the scan. The group may then be scanned down and then the next 20 lines may be scanned. These lines can be together or alternating (half fields) that may be interlaced in time.

Multiple laser scanned displays may be employed to enable display systems, screens, displays, and so forth, able to display three dimensional (3D) content. Two examples of methods for modifying these displays into 3D displays may employ polarization or multiple colors. Additionally, the intensity envelope function that may be employed across the display can be achieved, for example, by changes in laser power as the beam is scanned on the screen or by dwell time of the laser beam on these pixels. The intensity envelope will be discussed in further detail herein. In addition to tiling of individual light modules, the screens can be manufactured in larger areas and seamed together to make a large theater size screen and may use multiple light engines to drive the respective portion of the large screen. Further, these multiple laser scanned systems can be brighter and higher resolution than what may be generally used for cinema. Moreover, these displays can use autostereoscopic or 3D viewing without glasses techniques such as parallax barriers and lenticular lenses.

### 3D Displays

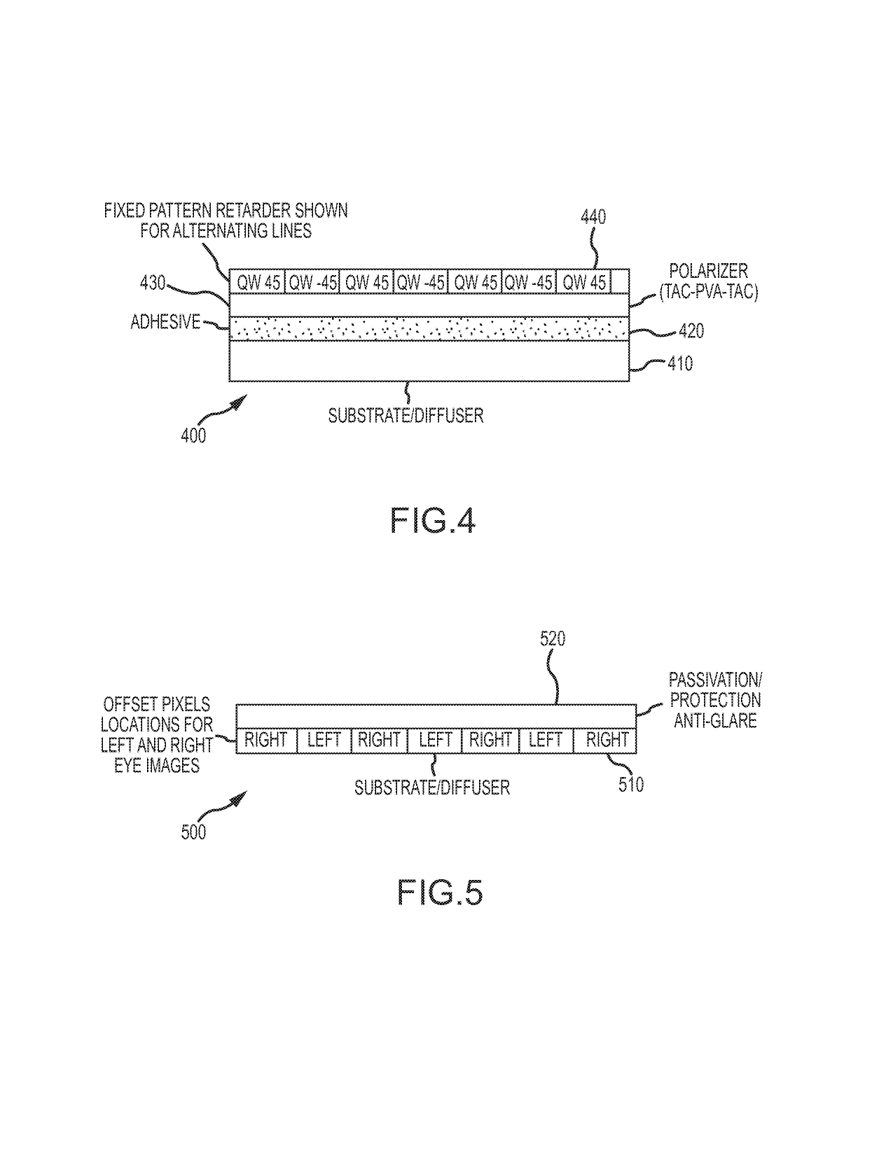

One approach to presenting 3D movies using this technology may be to use a polarizer and a film patterned retarder (FPR) film that may be fabricated as part of the screen. The film patterned retarder may be a liquid-crystal polymer with a quarter-wave of retardation. The retarder may be, for example, patterned in stripes with alternating orientations of ±45° relative to the input linear polarization. The right and left eye images to form the 3D image may then be presented on alternating lines or groups of pixels and may be separated into left and right eye images by polarizing eyewear. The screen for multiple color lasers scanned displays may include a diffuser which may be on or using a polymer structure. The diffuser may be illuminated with the appropriate amount of reddish, greenish, or bluish light to get the appropriate color and intensity for that given pixel on the screen. An example of such a structure for this type of display with a polarizer and FPR is illustrated in FIG. 4. In one example, the lasers may be polarized so that the polarizer in the screen may not be needed. In the example the lasers are not polarized and the other elements in the screen cause depolarization, then a polarizer can be used to clean up the light before the FPR so that high polarization contrast may be maintained.

FIG. 4 is a schematic diagram illustrating one embodiment of a display with a polarizer and a fixed pattern retarder. FIG. 4 illustrates a display 400 that includes a substrate 410, an adhesive layer 420, a polarizer layer 430, and a film patterned retarder 440. The polarizer layer 430 can be absorbing, for example, PVA, or reflective, for example, wire grid or other polarizing technology. The substrate 410 of FIG. 4 may be glass or plastic. The substrate 410 may include a protective layer and may be thin film coated for anti-reflection or anti-scratch, with for example, a SiO2 layer, or any other appropriate layer. Additionally, the substrate may be a transmissive diffuser. The FPR may cause a change in polarization state per line or group of pixels as defined by the light engine or the servo pattern on the back of the screen. As such, the layers may be approximately aligned relative to each other. The polarization state per eye can be any two approximately orthogonal states, but left and right circular may be employed to remain in accordance with general commercial use. The FPR can be lines allowing for alternating right and left eye images to be displayed per line or the FPR can be in alternating blocks or groups of pixels that can be used to present the two images appropriate for stereo 3D.

The layers of FIG. 4 can be manufactured in various ways including, but not limited to, roll-to-roll coating, thin film deposition and so forth. The FPR/polarizer film can be, for example, roll-to-roll laminated to the substrate or diffuser layer to reduce manufacturing cost. The FPR/polarizer film can be die cut and batch laminated to transparent substrate panels. The panels can then be joined to make screens with very small seams. The seams between panels, displays or screens of a laser scanned display may be small and in the approximate range of 0.05 mm-1 mm and can be masked by various methods including, but not limited to, using a diffuser in front of the screen, or by employing waveguides used on macro-pixels, aligning the seams to gaps in the pixel structure, and so forth, as generally discussed in U.S. patent application Ser. No. 13/655,261 and U.S. patent application Ser. No. 13/655,277, both of which are herein incorporated by reference in their entirety.

The substrate can have servo marks or fiducial marks that can be read by the light engine using a detector with a filter to read backscatter light of the color used by the servo beam to track illumination position somewhat accurately. This construction may be achieved by employing the substantially seamless techniques generally described in U.S. patent application Ser. No. 13/549,304, which is herein incorporated by reference in its entirety and may be used very effectively to make a large, visibly high quality, 3D display for cinema or large venue use.

Another embodiment for making 3D laser scanned displays may employ different color groupings for the left and right eye rather than different polarization. Here the different colors may be decoded into left and right eye images by glasses worn by a viewer. These glasses may have different notch color filters that may pass one group of colors but not another. A first set of red, green and blue colors may be used for the right eye image and a second set of color primaries may be used for the left eye. The light engine may employ six colors such as two blues, two red, and two green or R1, R2, B1, B2, G1, and G2. The first set of beams that correspond to the right image, for example, R1, G1, and B1 may strike the screen at a first location and the second set of beams may show a second set of colors for the left eye, for example, R2, G2, and B2 at a second location. The beams may be spatially offset which may cause two lines to be scanned at once. The entrance pupil of the scanning system of the engine may receive the beams that are spatially offset. Alternatively, the two color sets could encounter the screen at approximately the same location and the correct pixel value per eye may be determined by the transmission of the eyewear, screen, and the power levels of the laser sets. As above, the laser set or multiple laser sets can be scanned across the screen while modulated to create the appropriate images for stereo 3D viewing. The example of FIG. 5 illustrates that this may be achieved for alternating lines on the display or screen.

FIG. 5 is a schematic diagram illustrating one embodiment of a display system which may include a substrate or diffuser. The display system 500 of FIG. 5 includes a substrate 510 and a protective layer 520. The protective layer 520 may be a passivating layer, an anti-glare layer, and so forth. As previously discussed the protective layer 520 may be anti-reflective layer such as SiO2 or any other appropriate material. The substrate 510 may be a diffuser and may have AR and servo tracks/marks on it. In one embodiment, the diffuser may be a transmissive diffuser. Additionally, the diffuser may be any type of material including, but not limited to any plastic or glass material. A narrow spectrum for the lasers may allow for better system design, including reduced crosstalk, for a six color system. Generally, passbands for six color systems may be approximately a couple of tens of nanometers. Using sources that have less than approximately 15 nm FWHM bandwidth can allow for less crosstalk than such a system that uses lamps for illumination. The substrate 510 may also include offset pixel locations for a first and second of images which may correspond to a left eye image and a right eye image.

Generally, video walls may include individual modules. The individual modules may include a light engine, a screen, and a mechanical housing and may be arranged to form an array or video wall. A more commonly employed screen alternative in current cinema construction may include a screen with fewer seams. The entirety of the screen may include screen sections that are seamed together and in which the screen sections may not correspond to the individual modules. Additionally, the seams may not correspond to the individual modules. In one embodiment, a large theater sized screen can be manufactured with all of the appropriate layers and coatings by seaming together the panels/screens. Rolls may be made of the screen which may then be joined and installed, as generally described in U.S. patent application Ser. No. 13/549,304, which is herein incorporated by reference in its entirety. The substrate may be, but is not limited to, PET, PVC, PC, and so forth. Next, the large screen may be installed in the theater and light modules may be arranged behind a portion of the screen and may be illuminated and driven appropriately. As illustrated in FIG. 8, the light modules and/or engines may be held in a mechanical assembly to approximately maintain a position relative to the corresponding screen portion that may be illuminated and driven by the light module and/or engine. The screen may have servo marks and fiducial markings so that the screen may be self-aligned and/or calibrated on the corresponding portion of the screen that may be illuminated. Also, the whole assembly of light engines or part of the light engines may be enclosed for security and dust protection. The light engines may produce or emit light including, but not limited to, UV, RGB, visible, IR, deep blue light, approximately 405 nm, any combination thereof, and so forth.

The color and brightness across substantially the entire screen can be calibrated after installation so that the color and intensity uniformity may be appropriate across substantially the entire screen. The overall laser power can be monitored and substantially stabilized at these calibration values at least before and during operation of the unit.

### Envelope Function

Typical movie screens that receive light with projectors may have an intensity falloff from the center of the screen to the edges. For movies or projection technology, the edge intensity of the screen may be approximately 70-80% of the center intensity of the screen which complies with the DCI specification for theaters. For viewing rooms or small theaters that may be used to review movies for editing or an award screening, the desired falloff may be approximately 90%. In addition, theaters may include alternative content for the public such as sports and/or musical events. The alternative content may employ a different intensity profile than may be employed for movie content. This intensity fall off or intensity envelope function from center to edges may be a result of the natural intensity fall off due to the projector.

By using scanning illumination from behind the screen, screen intensity uniformity across the entire screen can be very good. In some cases, intensity uniformity across the tiled screen surface may not be desirable. For example, directors use the intensity falloff to focus the viewers' attention to the center of the screen. By employing a change in the illumination intensity as a function of scan position, a different intensity envelope function may be specified for a particular movie or even for individual scenes in the movie or event. In addition, intensity functions that are impossible to achieve with projectors can be achieved by these scanning beam screens. For example, flat intensity profiles or profiles with brighter edges than the center may be specified. The intensity envelope function can be achieved by changing the intensity of the illumination as a function of scan position, in which the beam may be currently illuminating the entire screen. These scanning beam displays can be much brighter than needed so this may be achieved without significantly affecting the desired overall brightness of the content. This limiting or scaling of intensity values may depend on position and may be achieved nearly continuously across the entire screen. The digital values that represent the content to be presented can be scaled by a digital processor and these values can then be changed into light intensity values by the changing the laser drive current or by changing the modulation of the beam to generate the desire envelope function.

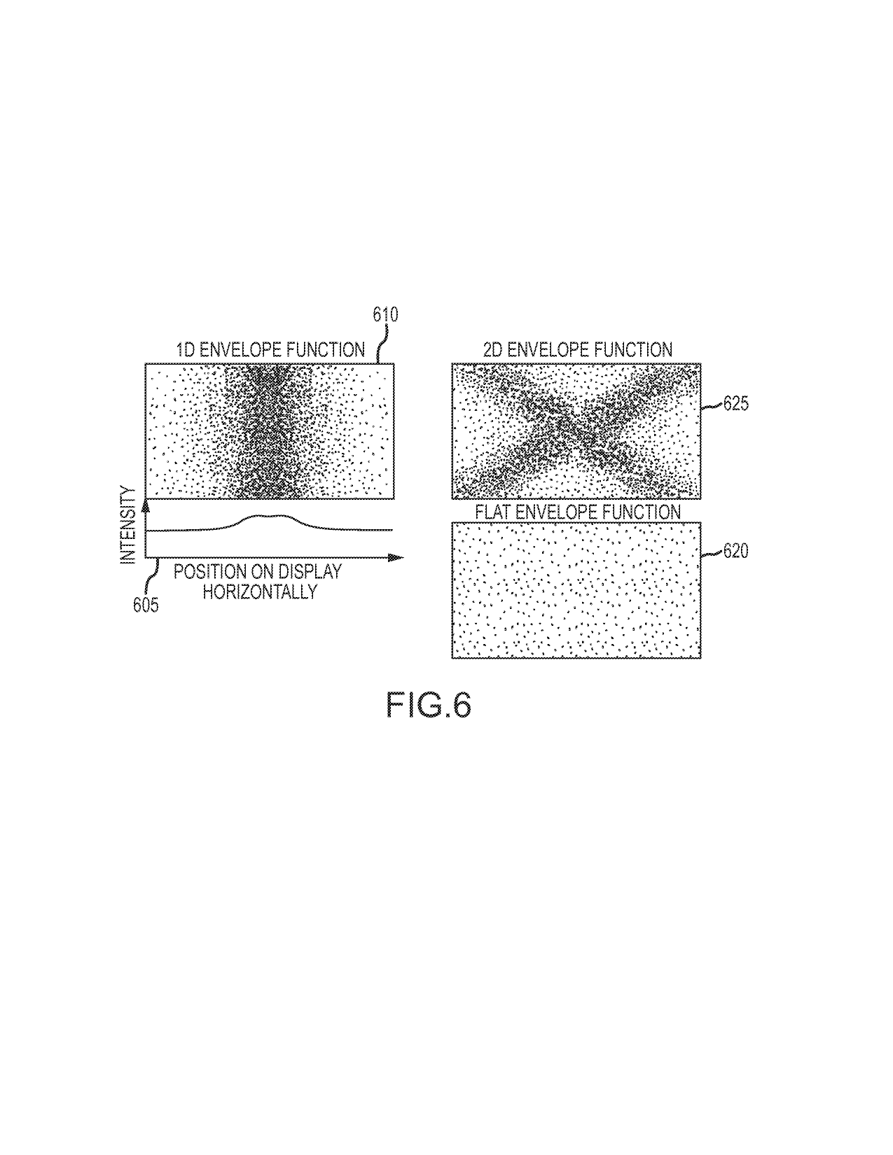

FIG. 6 is a schematic diagram illustrating examples of envelope functions. The envelope function can be one dimensional as shown in function 610 or substantially along the horizontal direction and uniform vertically. As illustrated in FIG. 6, intensity graph 605 varies in intensity in the horizontal direction and is substantially uniform in the vertical direction. The envelope function may be mostly uniform across the display as in 620. Also illustrated in FIG. 6, intensity function 625 varies in intensity in both the horizontal and vertical directions. These functions may be employed and specified for both 2D and 3D content.

### Autostereoscopic Structures for Laser Beam Scanned Systems

One embodiment may include recognition of considerable space per-pixel to incorporate additional spatial functionality via arrays of sub-pixels. For example, a pixel used in digital cinema may be approximately 5-6 mm in size at the screen, yet roll-to-roll manufactured diffractive/refractive structures and laser spot sizes can be substantially smaller. Roll-to-roll manufactured structures can have feature sizes on the order of tens of microns, and excitation sources may exist to address individual features of this size. As such, functions such as beam-steering, local power, phase control, and amplitude control can be achieved at the sub-pixel level by employing embodiments discussed herein. The ability to address arrays of sub-pixels with specific functionality may be used when implementing technologies such as autostereoscopic display. Conversely, it may be relatively difficult for AMLCD manufacturers to increase pixel density for high quality multi-view autostereoscopic display.

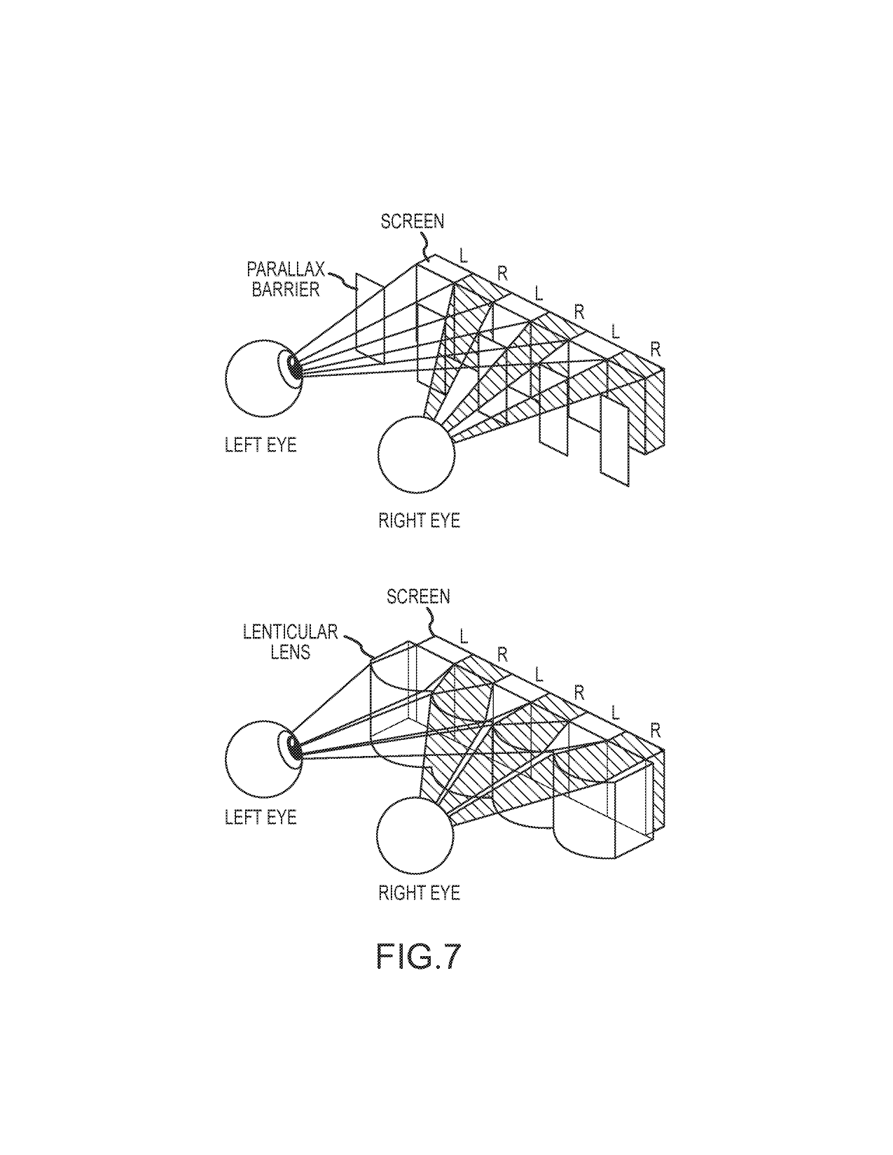

In one example, more pixels and/or sub-pixels) may be employed to achieve 3D autostereo and may be used with parallax barriers or lenticular lenses on top of a denser pixel grid. FIG. 7 is a schematic diagram illustrating embodiments of a parallax-barrier autostereoscopic display and lenticular autostereoscopic display. Both of these approaches may use the lenses or the barriers so that as the view angle changes the pixels that may be seen by the viewer also changes. This may allow the display to change the perceived image with a change in viewing angle as illustrated in FIG. 7. FIG. 7 illustrates parallax barriers and lenticular lens arrays. In FIG. 7, the right and left eyes perceive two different images due to the change in viewing angle between the eyes. By perceiving two different images, a 3D viewing experience may be enabled autostereoscopic viewing or without having to wear glasses.

The parallax barrier and lenticular lens structures may be placed on top of the screen structure, either under or on top of the protective layers so that different pixels may be addressed to show different images per viewing angle allowing for a 3D effect without wearing glasses. Generally, the appropriate number of views may be approximately 8-50 in the horizontal direction and approximately 2-5 in the vertical direction. Thus the number of extra sub-pixels may be similar or less than the total number of views for the same overall image resolution. Further, Parallax barriers and lenticular lens arrays may be demonstrated in the example of the right and left eyes viewing two different images due to the change in viewing angle between the eyes. By seeing two different images, a 3D viewing experience is enabled.

It should be noted that embodiments of the present disclosure may be used in a variety of optical systems and projection systems. The embodiment may include or work with a variety of projectors, projection systems, optical components, computer systems, processors, self-contained projector systems, visual and/or audiovisual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments including the Internet, intranets, local area networks, wide area networks and so on.

Before proceeding to the disclosed embodiments in detail, it should be understood that the embodiments are not limited in application or creation to the details of the particular arrangements shown, because the embodiment is capable of other variations. Moreover, aspects of the embodiment may be set forth in different combinations and arrangements to define embodiments unique in their own right. Also, the terminology used herein is for the purpose of description and not of limitation.

As may be used herein, the terms “substantially” and “approximately” provide an industry-accepted tolerance for its corresponding term and/or relativity between items. Such an industry-accepted tolerance ranges from less than one percent to ten percent and corresponds to, but is not limited to, component values, angles, et cetera. Such relativity between items ranges between less than one percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A stereoscopic display system, comprising:
a light source operable to produce light and a scanning system operable to scan a beam;
at least a first substrate and a second substrate joined together and operable to receive light from the light source; and
an FPR layer proximate to at least one of the first or second substrate.

2. The stereoscopic display system of claim 1, wherein the light source produces at least three colors of light.

3. The stereoscopic display system of claim 2, wherein the primary colors of light are substantially red, green, and blue.

4. The stereoscopic display system of claim 1, further comprising a polarizer proximate to the FPR layer.

5. The stereoscopic display system of claim 1, wherein the light source includes a first beam and a second beam.

6. The stereoscopic display system of claim 5, wherein the first beam and the second beam are polarized.

7. The stereoscopic display system of claim 5, wherein the light from the first beam and the light from the second beam are substantially combined by a polarizing beam splitter.

8. The stereoscopic display system of claim 1, wherein the light source includes a first beam, a second beam, and a third beam, wherein the light from each of the first, second, and third beam are substantially combined primarily using dichroic filters.

9. The stereoscopic display system of claim 1, wherein the light source includes a first beam, a second beam, and a third beam, wherein the light from each of the first, second, and third beam are substantially combined primarily using a mirror array structure.

10. The stereoscopic display system of claim 1, wherein the light source includes a first beam, a second beam, and a third beam, wherein the light from each of the first, second, and third beam are substantially combined primarily using a fiber combiner and a collimating lens.

11. The stereoscopic display system of claim 5, wherein the first beam and the second beam scan multiple lines substantially simultaneously.

12. The stereoscopic display system of claim 1, further comprising an array of light engines for illuminating at least the first and second substrate.

13. The stereoscopic display system of claim 1, wherein the first substrate and the second substrate are transmissive, diffusive substrates.

14. The stereoscopic display system of claim 5, further comprising beam combining optics which substantially combine colors into at least one of a single beam or closely spaced beams.

15. The stereoscopic display system of claim 14, further comprising at least a rotating polygon mirror for steering the beam to a desired location on at least the first or second substrate.

16. A stereoscopic scanned laser display system, comprising:
a light source operable to produce light and a scanning system operable to scan a beam;
at least a first substrate operable to receive light from the light source; and
an FPR layer proximate to the first substrate.

17. The stereoscopic scanned laser display system of claim 16, wherein the light source produces at least three primary colors of light that are substantially red, green, and blue.

18. The stereoscopic scanned laser display system of claim 16, further comprising a polarizer proximate to the FPR layer.

19. The stereoscopic scanned laser display system of claim 16, wherein the light source includes a first beam and a second beam, both of which are polarized.

20. The stereoscopic scanned laser display system of claim 19, wherein the light from the first beam and the light from the second beam are substantially combined primarily by a polarizing beam splitter.

21. The stereoscopic scanned laser display system of claim 16, wherein the light source includes a first beam, a second beam, and a third beam, wherein the light from each of the first, second, and third beam are substantially combined primarily using dichroic filters.

22. The stereoscopic scanned laser display system of claim 16, wherein the light source includes a first beam, a second beam, and a third beam, wherein the light from each of the first, second, and third beam are substantially combined primarily using a mirror array structure.

23. The stereoscopic scanned laser display system of claim 16, wherein the light source includes a first beam and a second beam which scan multiple lines substantially simultaneously.

24. A stereoscopic display system, comprising:
a light source operable to produce light and a scanning system operable to scan a beam;
at least a first substrate and a second substrate joined together and operable to receive light from the light source;
an FPR layer proximate to the first and second substrate; and
an array of light engines, wherein the first substrate is substantially illuminated by more than an individual light engine of the array of light engines.

25. The stereoscopic display system of claim 24, further comprising a polarizer proximate to the FPR layer.

26. A stereoscopic display system, comprising:
a light source operable to produce light and a scanning system operable to scan a beam, wherein the light source emits at least six colors; and
at least a first substrate operable to receive light from the light source.
